(19) United States
(12) Patent Application Publication
(10) Pub. No.: US 2006/0161280 A1
(43) Pub. Date: Jul. 20, 2006

(54) Integrated consumer video and/or audio circuit, audio system, or method of operating these with a stand-alone external video and/or audio reproduction device

(76) Inventors: Willy Platzer, Freiburg (DE); Dieter Baecher, Sexau (DE)

Correspondence Address: O'Shea, Getz & Kosakowski, P.C., Suite 912, 1500 Main Street, Springfield, MA, 01115, US

(21) Appl. No.: 11/333,794

(22) Filed: Jan. 17, 2006

(30) Foreign Application Priority Data
Jan. 14, 2005 (DE) 10 2005 002 099.2

(51) Int. Cl. G06F 17/00

(52) U.S. Cl. 700/94

(57) ABSTRACT

The invention relates to operating a stand-alone, in particular, portable video and/or audio reproduction device (MP3) as an external device (MP3) on an audio system (M), in which audio data (d) are supplied in the external device (MP3), the external device (MP3) is controllable so as to transmit audio data (d) through an interface (B) to the audio system (M), and the audio system (M) is designed and controlled in order to process and/or reproduce audio data (d), wherein control of the external device (MP3) is effected through the audio system. Analogously, the invention relates to an audio system, or to an integrated consumer video and/or audio circuit (IC) for this type of audio system, to control a stand-alone external audio reproduction device (MP3) by means of control signals from the audio system or consumer video and/or audio circuit.

### PRIORITY INFORMATION

This patent application claims priority from German patent application 10 2005 002 099.2 filed Jan. 14, 2005, which is hereby incorporated by reference.

### BACKGROUND OF THE INVENTION

The invention relates to multimedia systems, and in particular a multimedia system such as an audio system that receives and plays back data received from an external device via a directional bus and provides a control signal to the external device.

In the area of consumer electronics, audio systems that reproduce music through speakers are generally known. Audio data is supplied from various devices that are connected to the audio system or are integrated in this system. These audio systems (which include, for example, a single central device such as an amplifier with audio signal inputs or audio data inputs and speaker outputs) generally have a consumer video and/or audio circuit configured and arranged as one or more integrated circuits on a circuit board. The integrated consumer video and/or audio circuit controls the functions of the audio system and/or processes the received audio data in order to output music data.

Generally, audio systems also have a remote control that allows a user to control the audio system and its functions. Appropriate input control signals from the remote control are then transmitted, for example, through an infrared interface to the audio system, and are used by the consumer video and/or audio circuit integrated therein to control the audio system.

Generally, additional external devices are remotely controllable by a remote control in terms of the function of audio reproduction and the like, these devices including a CD player or a radio receiver that are connected through a cable to the audio system. In this regard, remote controls are generally known by which the separate devices are remotely-controllable independently of each other. Individual frequencies and/or signal codes are assigned, to the individual cable-interconnected devices by the remote control for the purpose of their individual control, with the result that the shared remote control effectively integrates a plurality of remote controls for the various different devices.

Portable audio reproduction devices, for example, MP3 players, CD audio players, and DAT players, are generally known which are connectable through an appropriate audio data input to an audio system. Control of these stand-alone portable audio reproduction devices is effected directly on these devices. However, many of these portable audio reproduction devices are not controllable with a dedicated remote control, with the result that in order to control these (e.g., to change to or skip a given music piece out of a plurality of music pieces) a user must reach for the respective device in order to operate it. The audio system has only one passive data input for inputting the audio data of this stand-alone portable external audio device through which the corresponding audio data are received.

Computers are generally known that are capable of processing video and/or audio data and reproducing these. In order to connect a portable external audio reproduction device in such as for example an MP3 player, both this device and the computer are interconnectable through a cable connection or a direct plug-in connection that enable audio data to be transmitted from the portable external audio reproduction device to the computer for playback there. Bidirectional bus connections on computers are generally known, for example, those based on the standards USB (universal serial bus) or FireWire. Through these bidirectional busses or connections, external devices can be controlled in terms of their function directly by a control device in the computer.

There is a need for an improved technique for operating a stand-alone portable video and/or audio reproduction device in the form of an external device on an audio system.

### SUMMARY OF THE INVENTION

An integrated circuit for controlling an audio system and an external audio storage device connected via a common control device includes a first interface that receives input commands and provides received input commands. A radio receiver provides received radio data to the audio system. A control circuit that comprises a control device and a bi-directional bus interface receives the received input commands and the received radio data, and provides an audio output signal. The control circuit also outputs an external device command signal via the bi-directional bus interface, and receives external device audio data via the bi-directional bus interface.

The bi-directional bus interface may be configured and arranged as a USB or FIREWIRE bus.

These and other objects, features and advantages of the present invention will become more apparent in light of the following detailed description of preferred embodiments thereof, as illustrated in the accompanying drawing.

### BRIEF DESCRIPTION OF THE DRAWINGS

FIG. 1 illustrates an audio system that receives and playbacks audio data from an external device via a bi-directional bus and provides control signals to the external device via the bi-directional bus.

### DETAILED DESCRIPTION OF THE INVENTION

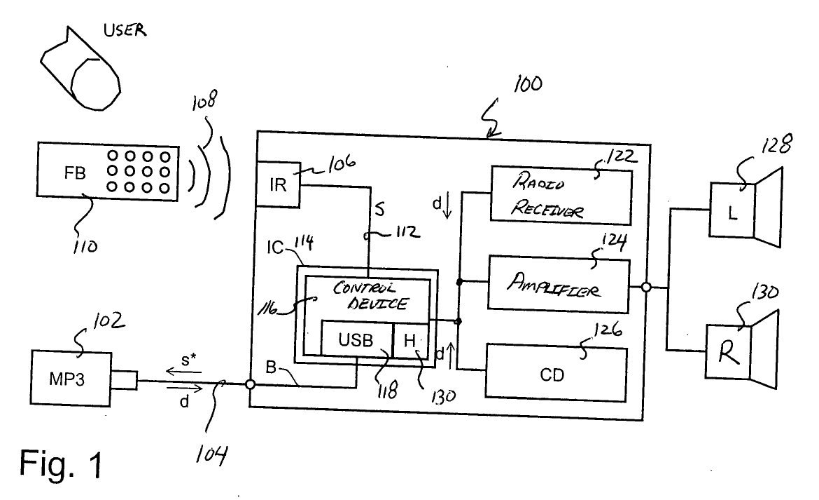

FIG. 1 illustrates an audio system 100 that receives and plays back audio data from an external device 102 via a bi-directional bus 104 and provides control signals to the external device via the bi-directional bus 104. The audio system 100 includes an infrared interface 106 that receives infrared signals 108 from a remote control 110, which is controlled by a user. The infrared interface 106 provides control signals on a line 112 to a control circuit 114 (e.g., an integrated circuit) that includes a control device 116 and a bi-directional bus interface 118.

The audio system 100 may also include a radio receiver 122, an amplifier 124 and a CD player 126. The radio receiver 122 and the CD player 126 provide audio data to the control circuit 114. The amplifier 124 selectively receives the audio data from the radio receiver 122 or the CD player 126 either directly or indirectly via the control circuit 114 and outputs amplified audio data to speakers 128, 130. Audio data from the external device 102 may also be provided to the amplifier 124 either directly or indirectly (e.g., via the control circuit 114) for amplification and output to the speakers 128, 130.

A user may control the audio system 100 via the remote control 110 or via a control panel located on the audio system 100. The input commands are provided to the control device 116, which processes the commands and issues the necessary instructions to perform the task requested by the input command.

In order to provide user with unified control of the audio system 100 and the stand-alone external device 102, the interface 118 is configured as a bidirectional interface. As a result, control signals s* can be transmitted from the audio system 100, for example, from the control circuit 114, or from the integrated consumer video and/or audio circuit 116, through the interface 118 to the stand-alone external device 102 to control the external device. As a result, the user of the external device 102 can connect the device to the audio system 100 (e.g., a home stereo system) via the interface 118, and can transmit and reproduce audio data d from the external device 102 distortion-free in full digital quality. In particular, the user can control the external device 102 through the audio system 100, and preferably, through the system remote control 110. As a result, functions of the stand-alone external device 102 connected to the audio system 100 such as start or stop for a music title, pause, selection of the next or a different music title, transmission of the music title itself for display on the audio system's display, et cetera, can be controlled using the remote control 110. The external device 102 can thus be controlled via the remote control 110 or via controls located on the audio device 100, by providing commands to the external device 102 via the bi-directional bus interface 118.

The bi-directional interface device 118 may be configured and arranged as a USB™ interface or a FIREWIRE™ interface. Application of this technology to audio devices, in particular, to both portable and stationary audio devices, provides an efficient and cost-effective mechanism of expanding the functionality of the audio system 100 and the stand-alone external device 102 as two-way controllable devices.

The bi-directional bus interface 118 can be integrated into the control circuit 114, preferably within the same integrated circuit. To the extent integrated consumer video and/or audio circuits already have a USB or FireWire interface, these may simply be expanded by adding a so-called host 130 functionality or a host. By doing so, conventional computer applications may now be used in the field of consumer audio equipment.

Advantageously, the audio device equipped with a bi-directional interface may control an external device (e.g., a portable device such as an MP3 player) and play audio data d received from the external device via the bi-directional bus.

Although the present invention has been illustrated and described with respect to several preferred embodiments thereof, various changes, omissions and additions to the form and detail thereof, may be made therein, without departing from the spirit and scope of the invention.

What is claimed is:

1. An integrated circuit for controlling an audio system and an audio storage device that is external to and connected to the audio storage device via a common control device, the integrated circuit comprising:
a first interface that receives input commands and provides received input commands;
a radio receiver that provides received radio data; and
a control circuit that includes a control device and a bi-directional bus interface, and receives the received input commands and the received radio data, provides an audio output signal, and outputs an external device command signal via the bi-directional bus interface, and receives external device audio data via the bi-directional bus interface.

2. The integrated circuit of claim 1, wherein the bi-directional interface comprises a USB interface.

3. The integrated circuit of claim 1, wherein the bi-directional interface comprises a FIREWIRE interface.

4. The integrated circuit of claim 1, wherein the control circuit comprises a processor and an executable host application.

5. The integrated circuit of claim 1, wherein the bi-directional bus interface is configured and arranged as a serial bus.

6. The integrated circuit of claim 1, wherein the bi-directional bus interface is configured and arranged as a parallel bus.

7. A method of controlling an audio system and an external source of audio data using a common control device, the method comprising:
receiving a command signal from the common control device;
processing the command signal and providing an external device command signal;
transmitting the external device command via a bi-directional bus interface to the external device;
receiving audio data from the external device via the bi-directional bus interface; and
providing processed audio data to a transducer.

8. The method of claim 7, wherein the step of transmitting comprises transmitting the external device command via a USB connection.

9. The method of claim 7, wherein the step of transmitting comprises transmitting the external device command via a FIREWIRE connection.

10. The method of claim 7, further comprising receiving radio data from a radio receiver and selectively outputting the processed audio data that is indicative of either the audio data or the radio data.

11. A system of controlling an audio system and an external source of audio data using a common control device, comprising:
means for receiving a command signal from the common control device;
means for processing the command signal and for providing an external device command signal;
means for transmitting the external device command via a bi-directional bus interface to the external device;
means for receiving audio data from the external device via the bi-directional bus interface; and
means for providing processed audio data to a transducer.
